(19) United States
(12) Patent Application Publication
(10) Pub. No.: US 2004/0088649 A1
(43) Pub. Date: May 6, 2004

(54) System and method for finding the recency of an information aggregate

(75) Inventors: Michael D. Elder, Greer, SC (US); Jason Y. Jho, Raleigh, NC (US); Vaughn T. Rokosz, Newton, MA (US); Andrew L. Schirmer, Andover, MA (US); Matthew Schultz, Ithaca, NY (US)

Correspondence Address: Shelley M. Beckstrand, Esq., Attorney at Law, 314 Main Street, Owego, NY, 13827-1616, US

(73) Assignee: International Business Machines Corporation, Armonk, NY

(21) Appl. No.: 10/286,262

(22) Filed: Oct. 31, 2002

(51) Int. Cl. G06F 15/00

(52) U.S. Cl. 715/501.1

(57) ABSTRACT

System for evaluating an information aggregate includes a metrics database for storing document indicia including document attributes, associated persons and time-stamped tracked activities; a query engine responsive to a user request and the metrics database for aggregating documents having same, unique attributes in an information aggregate; the query engine further for calculating recency value of the aggregate; and a visualization engine for visualizing recency values for a plurality of aggregates at a client display. Base recency, relative recency, cross-aggregate recency, and normalized cross-aggregate recency metrics are provided.

### CROSS REFERENCES TO RELATED APPLICATIONS

The following U.S. patent applications are filed concurrently herewith and are assigned to the same assignee hereof and contain subject matter related, in certain respect, to the subject matter of the present application. These patent applications are incorporated herein by reference.

Ser. No. ______, filed ______ for “SYSTEM AND METHOD FOR DETERMINING FOUNDERS OF AN INFORMATION AGGREGATE”, assignee docket LOT920020007US1;

Ser. No. ______, filed ______ for “SYSTEM AND METHOD FOR FINDING THE ACCELERATION OF AN INFORMATION AGGREGATE”, assignee docket LOT920020008US1;

Ser. No. ______, filed ______ for “SYSTEM AND METHOD FOR FINDING THE RECENCY OF AN INFORMATION AGGREGATE”, assignee docket LOT920020009US1;

Ser. No. ______, filed ______ for “SYSTEM AND METHOD FOR EXAMINING THE AGING OF AN INFORMATION AGGREGATE”, assignee docket LOT920020010US1;

Ser. No. ______, filed ______ for “SYSTEM AND METHOD FOR DETERMINING CONNECTIONS BETWEEN INFORMATION AGGREGATES”, assignee docket LOT920020011US1;

Ser. No. ______, filed ______ for “SYSTEM AND METHOD FOR DETERMINING MEMBERSHIP OF INFORMATION AGGREGATES”, assignee docket LOT920020012US1;

Ser. No. ______, filed ______ for “SYSTEM AND METHOD FOR EVALUATING INFORMATION AGGREGATES BY VISUALIZING ASSOCIATED CATEGORIES”, assignee docket LOT920020017US1;

Ser. No. ______, filed ______ for “SYSTEM AND METHOD FOR DETERMINING COMMUNITY OVERLAP”, assignee docket LOT920020018US1;

Ser. No. ______ , filed ______ for “SYSTEM AND METHOD FOR BUILDING SOCIAL NETWORKS BASED ON ACTIVITY AROUND SHARED VIRTUAL OBJECTS”, assignee docket LOT920020019US1; and

Ser. No. ______, filed ______ for “SYSTEM AND METHOD FOR ANALYZING USAGE PATTERNS IN INFORMATION AGGREGATES”, assignee docket LOT920020020US1.

### BACKGROUND OF THE INVENTION

1. Technical Field of the Invention

This invention relates to a method and system for analyzing trends in an information aggregate. More particularly, it relates to identifying and visualizing recency of collections of aggregates.

2. Background Art

Corporations are flooded with information. The Web is a huge and sometimes confusing source of external information which only adds to the body of information generated internally by a corporation's collaborative infrastructure (e-Mail, Notes databases, QuickPlaces, and so on). With so much information available, it is difficult to determine what's important and what's worth looking at.

There are systems that attempt to identify important documents, but these systems are focused on individual documents and not on aggregates of documents. For example, search engines look for documents based on specified keywords, and rank the results based on how well search keywords match the target documents. Each individual document is ranked, but collections of documents are not analyzed.

Systems that support collaborative filtering provide a way to assign a value to documents based on user activity, and can then find similar documents. For example, Amazon.com can suggest books to a patron by looking at the books purchased in the past. Purchases can be rated by the patron to help the system determine the value of those books to him, and Amazon can then find similar books (based on the purchasing patterns of other people).

The Lotus Discovery Server (LDS) is a Knowledge Management (KM) tool that allows users to more rapidly locate the people and information they need to answer their questions. It categorizes information from many different sources (referred to generally as knowledge repositories) and provides a coherent entry point for a user seeking information. Moreover, as users interact with LDS and the knowledge repositories that it manages, LDS can learn what the users of the system consider important by observing how users interact with knowledge resources. Thus, it becomes easier for users to quickly locate relevant information.

The focus of LDS is to provide specific knowledge or answers to localized inquiries; focusing users on the documents, categories, and people who can answer their questions. There is a need, however, to magnify existing trends within the system—thus focusing on the system as a whole instead of specific knowledge. In particular, new information is often of more interest than old information.

It is an object of the invention to provide an improved system and method for detecting and visualizing new information.

### SUMMARY OF THE INVENTION

A system and method for evaluating information aggregates by collecting a plurality of documents having non-unique values on a shared attribute into an information aggregate; time stamping tracked activities on the documents; calculating recency of the information aggregate; and visualizing the recency for a plurality of information aggregates.

In accordance with an aspect of the invention, there is provided a computer program product configured to be operable for evaluating information aggregates by collecting a plurality of documents having non-unique values on a shared attribute into an information aggregate; time stamping tracked activities on the documents; calculating recency of the information aggregate; and visualizing the recency for a plurality of information aggregates.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a diagrammatic representation of visualization portfolio strategically partitioned into four distinct domains in accordance with the preferred embodiment of the invention.

FIG. 2 is a system diagram illustrating a client/server system in accordance with the preferred embodiment of the invention.

FIG. 3 is a system diagram further describing the web application server of FIG. 2.

FIG. 4 is a diagrammatic representation of the XML format for wrapping SQL queries.

FIG. 5 is a diagrammatic representation of a normalized XML format, or QRML.

FIG. 6 is a diagrammatic representation of an aggregate in accordance with the preferred embodiment of the invention.

FIG. 7 is a bar chart visualizing the cross-aggregate recency (Rcross) for a set of categories in accordance with the preferred embodiment of the invention.

### DETAILED DESCRIPTION OF PREFERRED EMBODIMENTS

In accordance with the preferred embodiment of the invention, a recency metric is provided for evaluating information aggregates. In an exemplary embodiment of the invention, the recency metric may be implemented in the context of the Lotus Discovery Server (a product sold by IBM Corporation).

The Discovery Server tracks activity metrics for the documents that it organizes, including when a document is created, modified, responded to, or linked to. This allows the calculation of category recency and visualization of these recency values for all categories in, for example, a bar chart. Here “recency” is a measure of how long it has been since there was any activity within a category.

The Lotus Discovery Server (LDS) is a Knowledge Management (KM) tool that allows users to more rapidly locate the people and information they need to answer their questions. In an exemplary embodiment of the present invention, the functionality of the Lotus Discovery Server (LDS) is extended to include useful visualizations that magnify existing trends of an aggregate system. Useful visualizations of knowledge metric data store by LDS are determined, extracted, and visualized for a user.

On its lowest level, LDS manages knowledge resources. A knowledge resources is any form of document that contains knowledge or information. Examples include Lotus WordPro Documents, Microsoft Word Documents, webpages, postings to newsgroups, etc. Knowledge resources are typically stored within knowledge repositories—such as Domino.Doc databases, websites, newsgroups, etc.

When LDS is first installed, an Automated Taxonomy Generator (ATG) subcomponent builds a hierarchy of the knowledge resources stored in the knowledge repositories specified by the user. For instance, a document about working with XML documents in the Java programming language stored in a Domino.Doc database might be grouped into a category named ‘Home>Development>Java>XML’. This categorization will not move or modify the document, just record its location in the hierarchy. The hierarchy can be manually adjusted and tweaked as needed once initially created.

A category is a collection of knowledge resources and other subcategories of similar content, generically referred to as documents, that are concerned with the same topic. A category may be organized hierarchically. Categories represent a more abstract re-organization of the contents of physical repositories, without displacing the available knowledge resources. For instance, in the following hierarchy:

Home (Root of the hierarchy)

Animals

Dogs

Cats

Industry News and Analysis

CNN

ABC News

MSNBC

‘Home>Animals’, ‘Home>Industry News and Analysis’, and ‘Home>Industry News and Analysis>CNN’ are each categories that can contain knowledge resources and other subcategories. Furthermore, ‘Home>Industry News and Analysis>CNN’ might contain documents from www.cnn.com and documents created by users about CNN articles which are themselves stored in a Domino.Doc database.

A community is a collection of documents that are of interest to a particular group of people collected in an information repository. The Lotus Discovery Server (LDS) allows a community to be defined based on the information repositories used by the community. Communities are defined by administrative users of the system (unlike categories which can be created by LDS and then modified). If a user interacts with one of the repositories used to define Community A, then he is considered an active participant in that community.

Another capability of LDS is its search functionality. Instead of returning only the knowledge resources (documents) that a standard web-based search engine might locate, LDS also returns the categories that the topic might be found within and the people that are most knowledge about that topic.

The system and method of the preferred embodiments of the invention are built on a framework that collectively integrates data-mining, user-interface, visualization, and server-side technologies. An extensible architecture provides a layered process of transforming data sources into a state that can be interpreted and outputted by visualization components. This architecture is implemented through Java, Servlets, JSP, SQL, XML, and XSLT technology, and essentially adheres to a model-view controller paradigm, where interface and implementation components are separated. This allows effective data management and server side matters such as connection pooling to be independent

In accordance with the preferred embodiment of the invention, information visualization techniques are implemented through the three main elements including bar charts, pie charts, and tables. Given the simplicity of the visualization types themselves, the context in which they are contained and rendered is what makes them powerful mediums to reveal and magnify hidden knowledge dynamics within an organization.

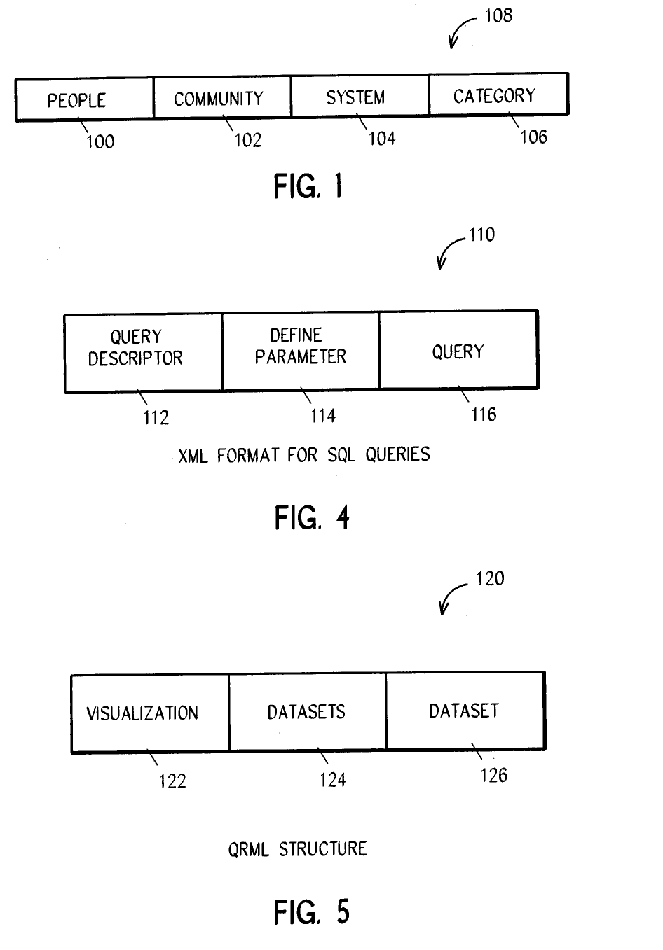

Referring to FIG. 1, a visualization portfolio is strategically partitioned into four distinct domains, or explorers: people 100, community 102, system 104, and category 106. The purpose of these partitioned explorers 100-106 is to provide meaningful context for the visualizations. The raw usage pattern metrics produced from the Lotus Discovery Server (LDS) do not raise any significant value unless there is an applied context to it. In order to shed light on the hidden relationships behind the process of knowledge creation and maintenance, there is a need to ask many important questions. Who are the knowledge creators? Who are the ones receiving knowledge? What group of people are targeted as field experts? How are groups communicating with each other? Which categories of information are thriving or lacking activity? How is knowledge transforming through time? While answering many of these questions, four key targeted domains, or explorer types 100-106 are identified, and form the navigational strategy for user interface 108. This way, users can infer meaningful knowledge trends and dynamics that are context specific.

### People Domain 100

People explorer 100 focuses on social networking, community connection analysis, category leaders, and affinity analysis. The primary visualization component is table listings and associations.

### Community Domain 102

Community explorer 102 focuses on acceleration, associations, affinity analysis, and document analysis for communities. The primary visualization components are bar charts and table listings. Features include drill down options to view associated categories, top documents, and top contributors.

One of the most interesting of the community visualizations is how fast the community is growing. This allows a user to instantly determine which communities are growing and which communities are stabilizing. A stabilizing community is one in which the user base has not grown much recently. That does not mean necessarily that the community is not highly active, it simply means that there have not been many additions in the user base. Communities that grow quickly could indicate new teams that are forming, and also denote spurts in the interests of the user base in a new topic (perhaps sales of a new product or a new programming language).

The document activity over time metric allows a more fine-grained measure of community activity. LDS maintains a record of the activity around documents. This means that if a user authors a document, links to a document, accesses a document, etc., LDS remembers this action and later uses this to calculate affinities. However, by analyzing these metrics relative to the available communities, an idea of the aggregate activity of a community in relation to the individual metrics may be derived. That is, by summing all of the ‘author’ metrics for communities A, B, C, etc, and doing this for all possible metrics, yields a quick visualization of the total document activity over time, grouped by community.

### System Domain 104

System explorer 104 focuses on high level activity views such as authors, searches, accesses, opens, and responses for documents. The primary visualization components are bar charts (grouped and stacked). Features include zooming and scrollable regions.

### Category Domain 106

Category explorer 106 focuses on lifespan, recency, acceleration, affinity analysis, and document analysis of categories generated by a Lotus Discovery Server's Automated Taxonomy Generator. The primary visualization components are bar charts. Features include drill down options to view subcategories, top documents, top contributors, category founders, and document activity.

### System Overview

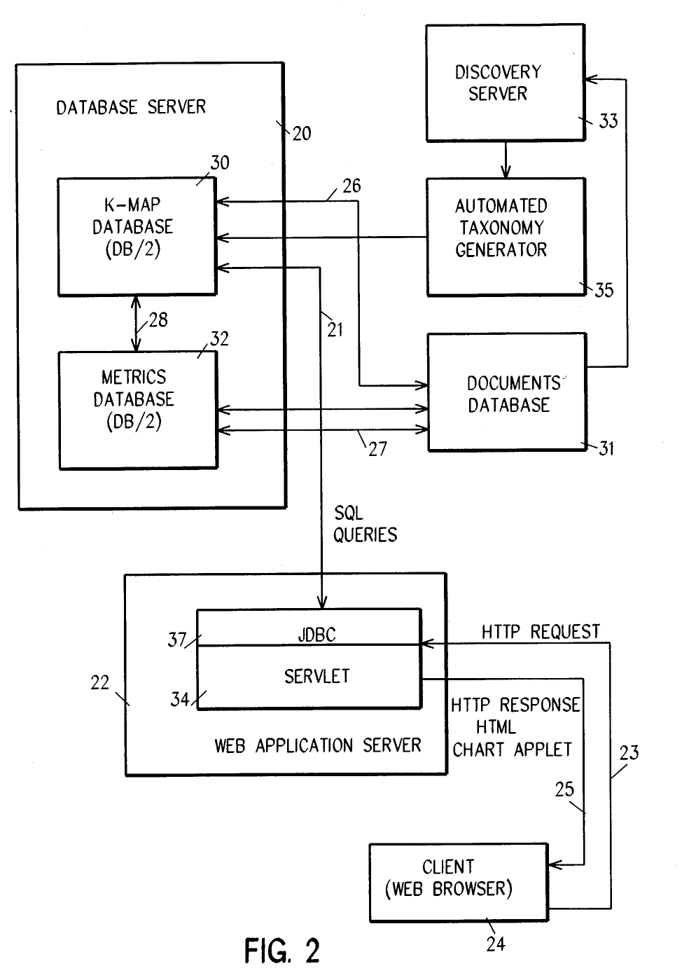

Referring to FIG. 2, an exemplary client/server system is illustrated, including database server 20, discovery server 33, automated taxonomy generator 35, web application server 22, and client browser 24.

Knowledge management is defined as a discipline to systematically leverage information and expertise to improve organizational responsiveness, innovation, competency, and efficiency. Discovery server 33 (e.g. Lotus Discovery Server) is a knowledge system which may deployed across one or more servers. Discovery server 33 integrates code from several sources (e.g., Domino, DB2, InXight, KeyView and Sametime) to collect, analyze and identify relationships between documents, people, and topics across an organization. Discovery server 33 may store this information in a data store 31 and may present the information for browse/query through a web interface referred to as a knowledge map (e.g., K-map) 30. Discovery server 33 regularly updates knowledge map 30 by tracking data content, user expertise, and user activity which it gathers from various sources (e.g. Lotus Notes databases, web sites, file systems, etc.) using spiders.

Database server 20 includes knowledge map database 30 for storing a hierarchy or directory structure which is generated by automated taxonomy generator 35, and metrics database 32 for storing a collection of attributes of documents stored in documents database 31 which are useful for forming visualizations of information aggregates. The k-map database 30, the documents database 31, and the metrics database are directly linked by a key structure represented by lines 26, 27 and 28. A taxonomy is a generic term used to describe a classification scheme, or a way to organize and present information, Knowledge map 30 is a taxonomy, which is a hierarchical representation of content organized by a suitable builder process (e.g., generator 35).

A spider is a process used by discovery server 33 to extract information from data repositories. A data repository (e.g. database 31) is defined as any source of information that can be spidered by a discovery server 33.

Java Database Connectivity API (JDBC) 37 is used by servlet 34 to issue Structured Query Language (SQL) queries against databases 30, 31, 32 to extract data that is relevant to a users request 23 as specified in a request parameter which is used to filter data. Documents database 31 is a storage of documents in, for example, a Domino database or DB2 relational database.

The automated taxonomy generator (ATG) 35 is a program that implements an expectation maximization algorithm to construct a hierarchy of documents in knowledge map (K-map) metrics database 32, and receives SQL queries on link 21 from web application server 22, which includes servlet 34. Servlet 34 receives HTTP requests on line 23 from client 24, queries database server 20 on line 21, and provides HTTP responses, HTML and chart applets back to client 24 on line 25.

Discovery server 33, database server 20 and related components are further described in U.S. patent application Ser. No. 10,044,914 filed 15 Jan. 2002 for System and Method for Implementing a Metrics Engine for Tracking Relationships Over Time.

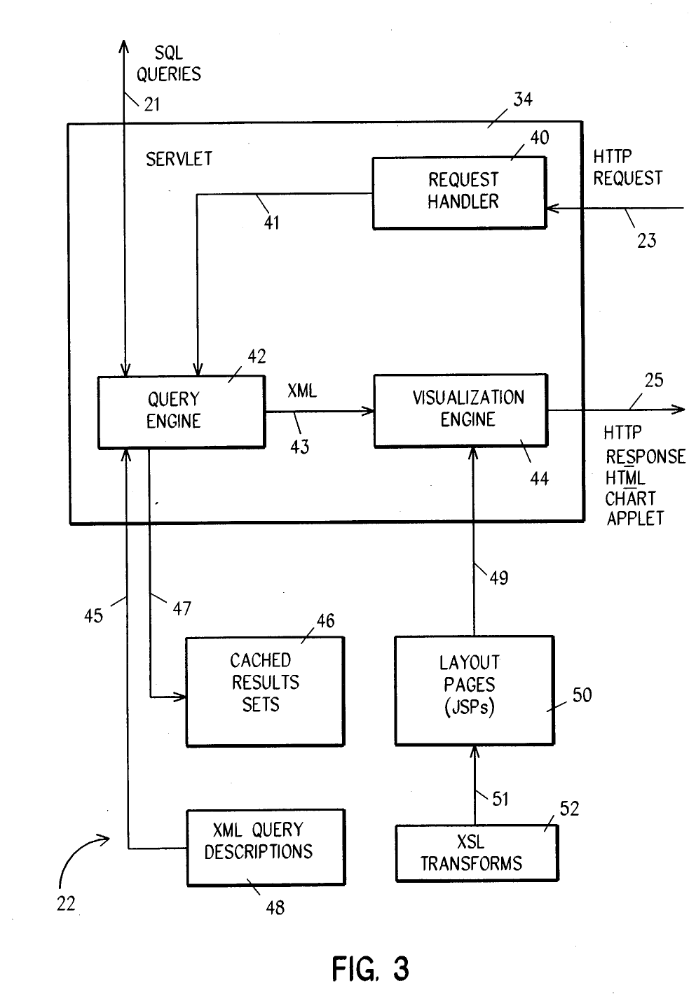

Referring to FIG. 3, web application server 22 is further described. Servlet 34 includes request handler 40 for receiving HTTP requests on line 23, query engine 42 for generating SQL queries on line 21 to database server 20 and result set XML responses on line 43 to visualization engine 44. Visualization engine 44, selectively responsive to XML 43 and layout pages (JSPs) 50 on line 49, provides on line 25 HTTP responses, HTML, and chart applets back to client 24. Query engine 42 receives XML query descriptions 48 on line 45 and caches and accesses results sets 46 via line 47. Layout pages 50 reference XSL transforms 52 over line 51.

In accordance with the preferred embodiment of the invention, visualizations are constructed from data sources 32 that contain the metrics produced by a Lotus Discovery Server. The data source 32, which may be stored in an IBM DB2 database, is extracted through tightly coupled Java and XML processing.

Referring to FIG. 4, the SQL queries 21 that are responsible for extraction and data-mining are wrapped in a result set XML format having a schema (or structure) 110 that provides three main tag elements defining how the SQL queries are executed. These tag elements are <queryDescriptor> 112, <defineparameter> 114, and <query> 116.

The <queryDescriptor> element 112 represents the root of the XML document and provides an alias attribute to describe the context of the query. This <queryDescriptor> element 112 is derived from http request 23 by request handlekr 40 and fed to query engine 42 as is represented by line 41.

The <defineparameter> element 114 defines the necessary parameters needed to construct dynamic SQL queries 21 to perform conditional logic on metrics database 32. The parameters are set through its attributes (localname, requestparameter, and defaultvalue). The actual parameter to be looked up is requestParameter. The localname represents the local alias that refers to the value of requestParameter. The defaultvalue is the default parameter value.

QRML structure 116 includes <query> element 116 containing the query definition. There can be one or more <query> elements 116 depending on the need for multiple query executions. A <data> child node element is used to wrap the actual query through its corresponding child nodes. The three essential child nodes of <data> are <queryComponent>, <useParameter>, and <queryAsFullyQualified>. The <queryComponent> element wraps the main segment of the SQL query. The <useparameter> element allows parameters to be plugged into the query as described in <defineParameter>. The <queryAsFullyQualified> element is used in the case where the SQL query 21 needs to return an unfiltered set of data.

When a user at client browser 24 selects a metric to visualize, the name of an XML document is passed as a parameter in HTTP request 23 to servlet 34 as follows:

<input type=hidden name=“queryAlias” value=“AffinityPerCategory”>

In some cases, there is a need to utilize another method for extracting data from the data source 32 through the use of a generator Java bean. The name of this generator bean is passed as a parameter in HTTP request 23 to servlet 34 as follows:

<input type=hidden name=“queryAlias”value=“PeopleInCommonByCommGenerator”>

Once servlet 34 receives the XML document name or the appropriate generator bean reference at request handler 40, query engine 42 filters, processes, and executes query 21. Once query 21 is executed, data returned from metrics database 32 on line 21 is normalized by query engine 42 into an XML format 43 that can be intelligently processed by an XSL stylesheet 52 further on in the process.

Referring to FIG. 5, the response back to web application server 22 placed on line 21 is classified as a Query Response Markup Language (QRML) 120. QRML 120 is composed of three main elements. They are <visualization> 122, <datasets> 124, and <dataset> 126. QRML structure 120 describes XML query descriptions 48 and the construction of a result set XML on line 43.

The <visualization> element 122 represents the root of the XML document 43 and provides an alias attribute to describe the tool used for visualization, such as a chart applet, for response 25.

The <datasets> element 124 wraps one or more <dataset> collections depending on whether multiple query executions are used.

The <dataset> element 126 is composed of a child node <member> that contains an attribute to index each row of returned data. To wrap the raw data itself, the <member> element has a child node <elem> to correspond to column data.

### Data Translation and Visualization

Referring further to FIG. 3, for data translation and visualization, in accordance with the architecture of an exemplary embodiment of the invention, an effective delineation between the visual components (interface) and the data extraction layers (implementation) is provided by visualization engine 44 receiving notification from query engine 42 and commanding how the user interface response on line 25 should be constructed or appear. In order to glue the interface to the implementation, embedded JSP scripting logic 50 is used to generate the visualizations on the client side 25. This process is two-fold. Once servlet 34 extracts and normalizes the data source 32 into the appropriate XML structure 43, the resulting document node is then dispatched to the receiving JSP 50. Essentially, all of the data packaging is performed before it reaches the client side 25 for visualization. The page is selected by the value parameter of a user HTTP request, which is an identifier for the appropriate JSP file 50. Layout pages 50 receive the result set XML 120 on line 43, and once received an XSL transform takes effect that executes a transformation to produce parameters necessary to launch the visualization.

For a visualization to occur at client 24, a specific set of parameters needs to be passed to the chart applet provided by, for example, Visual Mining's Netcharts solution. XSL transformation 52 generates the necessary Chart Definition Language (CDLs) parameters, a format used to specify data parameters and chart properties. Other visualizations may involve only HTML (for example, as when a table of information is displayed).

An XSL stylesheet (or transform) 52 is used to translate the QRML document on line 43 into the specific CDL format shown above on line 25.

This process of data retrieval, binding, and translation all occur within a JSP page 50. An XSLTBean opens an XSL file 52 and applies it to the XML 43 that represents the results of the SQL query. (This XML is retrieved by calling queryResp.getDocumentElement( )). The final result of executing this JSP 50 is that a HTML page 25 is sent to browser 24. This HTML page will include, if necessary, a tag that runs a charting applet (and provides that applet with the parameters and data it needs to display correctly). In simple cases, the HTML page includes only HTML tags (for example, as in the case where a simple table is displayed at browser 24). This use of XSL and XML within a JSP is a well-known Java development practice.

In Ser. No. ______, filed ______ for “SYSTEM AND METHOD FOR DETERMINING FOUNDERS OF AN INFORMATION AGGREGATE”, assignee docket LOT920020007US1, Table 1 illustrates an example of XML structure 110; Table 2 illustrates an example of the normalized XML, or QRML, structure; Table 3 illustrates an example of CDL defined parameters fed to client 24 on line 25 from visualization engine 44; Table 4 illustrates an example of how an XSL stylesheet 52 defines translation; and Table 5 is script illustrating how pre-packaged document node 43 is retrieved and how an XSL transformation 52 is called to generate the visualization parameters.

An exemplary embodiment of the system and method of the invention may be built using the Java programming language on the Jakarta Tomcat platform (v3.2.3) using the Model-View-Controller (MVC) (also known as Model 2) architecture to separate the data model from the view mechanism.

### Information Aggregate

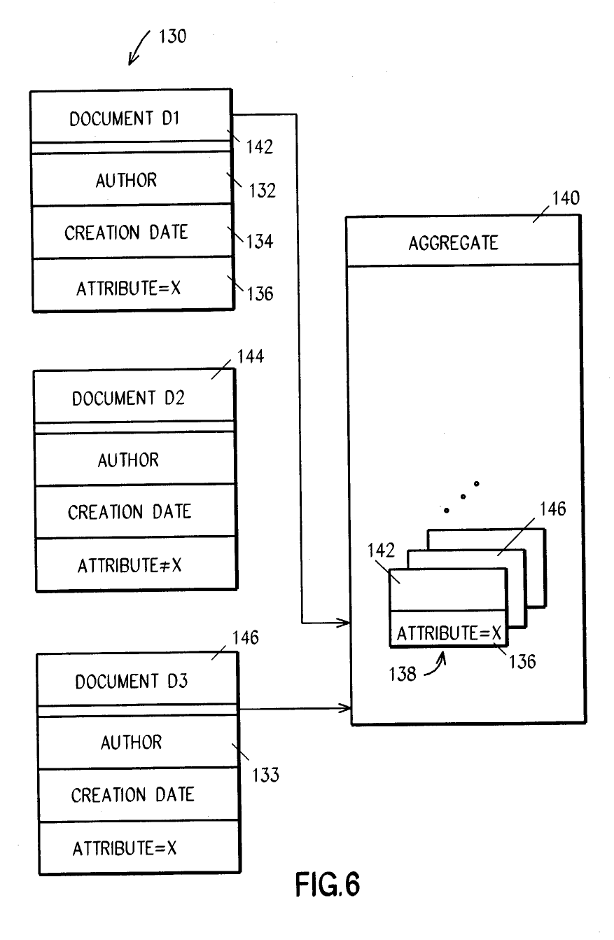

Referring to FIG. 6, a system in accordance with the present invention contains documents 130 such as Web pages, records in Notes databases, and e-mails. Each document 130 is associated with its author 132, and the date of its creation 134. A collection of selected documents 130 forms an aggregates 140. An aggregate 140 is a collection 138 of documents 142, 146 having a shared attribute 136 having non-unique values. Documents 138 can be aggregated by attributes 136 such as:

Category—a collection of documents 130 about a specific topic.

Community—a collection of documents 130 of interest to a given group of people.

Location—a collection of documents 130 authored by people in a geographic location (e.g. USA, Utah, Massachusetts, Europe).

Job function or role—a collection of documents 130 authored by people in particular job roles (e.g. Marketing, Development).

Group (where group is a list of people)—a collection of documents authored by a given set of people.

Any other attributed 136 shared by a group (and having non-unique values).

### Recency Metric

In accordance with the preferred embodiment of the invention, a recency metric that helps people locate interesting sources of information is provided. This metric is used for visualizing when aggregates have last been active. Use of recency metric visualizations improves organizational effectiveness by enabling people to identify interesting and useful sources of information more quickly.

The recency metric is used in a system that has the following characteristics:

The system contains documents. (Examples of documents include Web pages, records in Notes databases, and e-mails).

Document activity can be tracked and time stamped. Examples of tracked activities can include:

When the document was created

When someone responds to a document (for example, as in a discussion database or newsgroup)

When a document is modified

When someone creates a new document that contains a reference to the original document

Documents are collected together into aggregates.

Recency is a measure of when there was last activity in an information aggregate. The recency metric is calculated as the number of days since any activity was detected:

R=Dnow−Da

where Dnow is the current date, and Da the date of the most recent activity for any document in the aggregate.

When an information aggregate has a low recency value, there has been activity in the aggregate recently. Aggregates that are active are typically more valuable (and interesting) than aggregates that are inactive. This then helps to solve the problem of identifying where there is important information in a corporation.

There are a number of possible aggregates to which recency can be applied. Examples of how documents can be aggregated include (but are not limited to):

Category—a collection of documents that are about a given topic.

Community—a collection of documents that is of interest to a given group of people.

Location—a collection of documents authored by people in a geographic location (e.g. USA, Massachusetts, Utah, Europe).

Job function or role—a collection of documents authored by people in particular job roles (e.g. Marketing, Development).

Group (where group is a list of people)—a collection of documents authored by a given set of people.

One variation on this metric is relative recency. Relative recency is calculated as amount of time between the oldest and the most recent activity (also referred to as life-span), expressed as a percentage of the age of the aggregate:

Rrelative=(Da−Dold)/(Dnow−Dold)×100%

Rrelative=100% when Dnow=Dold To find relative recency, we first find the following values:

Where Dold is the date of the oldest activity for any document in the aggregate, Da is the date of the most recent activity for any document in the aggregate, and Dnow is the current date.

Relative recency is therefore high when an aggregate shows recent activity, and it is low when an aggregate has been inactive. Relative recency is most useful in looking at how the recency of an aggregate varies over time, since the normalization to a percentage keeps the recency value within a known range.

Another variation is cross-aggregate recency, calculated and visualized with respect to collection of aggregates (for example, a set of categories). To find the cross-aggregate recency, the number of days since the oldest activity across all of the aggregates of interest (Dold-all) is determined, and the recency R for each individual aggregate as described previously. (In this sense, “days” is used as a generic term for any similar period of time, such as weeks, months, etc.) The cross-aggregate recency is then:

Rcross=Dold-all−R

Rcross is high when there has been recent activity.

Another recency metric is normalized cross-aggregate recency. This is Rcross expressed as a percentage:

RcrossN=(Dold-all−R)/Dold-all×100%

RcrossN=100% when Dold-all=0

The normalized cross-aggregate recency will therefore always be in the range of 0 to 100, with the value of 100 representing those aggregates with activity today. Normalization gives a slight advantage in displaying the results, since Rcross will typically increase over time.

The recency metric is different from collaborative filtering in that it focuses on collections of documents, rather than individual documents. Using a collection to generate metrics can provide more context to people who are looking for information. Recency also focused on what happens in the time dimension, as opposed to traditional search engines which focus primarily on document content.

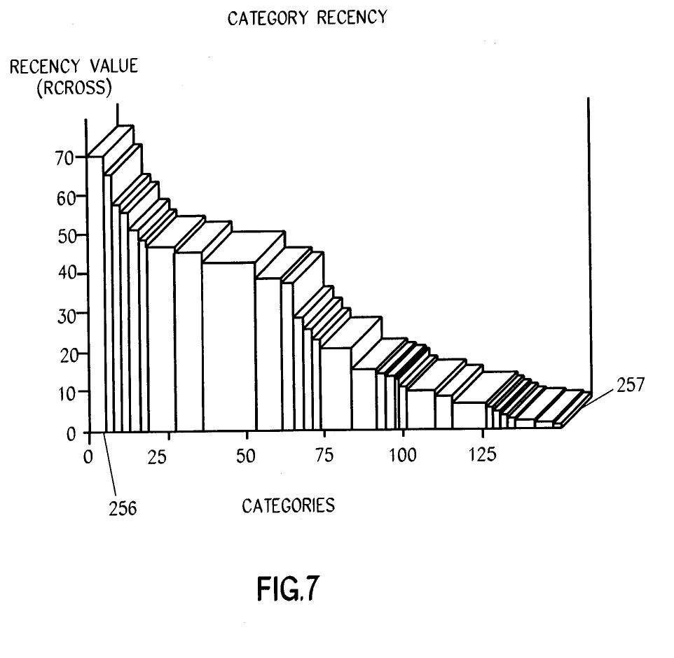

FIG. 7 shows the cross-aggregate recency (Rcross) for a set of categories, with the recency values sorted and displayed from highest to lowest.

Category 256 on the far left is the category that is most active, while category 257 on the far right is the category which has been inactive for longest. In some sense, then, this chart tells us what a corporation is thinking about (the high recency categories) and what the corporation has stopped thinking about (the low recency categories).

### Advantages Over the Prior Art

It is an advantage of the invention that there is provided an improved system and method for detecting and visualizing new information.

### Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for evaluating information aggregates, comprising:
collecting a plurality of documents having non-unique values on a shared attribute into an information aggregate;
time stamping tracked activities on said documents;
calculating recency of said information aggregate; and
visualizing said recency for a plurality of said information aggregates.

2. The method of claim 1, said recency being base recency calculated for a given aggregate as time elapsed since the last tracked activity for any said document in said given aggregate.

3. The method of claim 1, said recency being relative recency, calculated as a ratio of life-span of said aggregated to age of said aggregate.

4. The method of claim 1, said recency being cross aggregate recency, calculated for an individual aggregate with respect to a collection of aggregates as a number of time periods since an oldest activity across said collection of aggregates minus said base recency for said individual aggregate.

5. The method of claim 1, said recency being normalized cross-aggregate recency calculated for each individual aggregate as the ratio of a number of time periods since the oldest activity across said collection of aggregates minus said base recency for said individual aggregate to said time periods since said oldest activity across said collection of aggregates.

6. A system for evaluating information aggregates, comprising:
means for collecting a plurality of documents having non-unique values on a shared attribute into an information aggregate;
means for time stamping tracked activities on said documents;
means for calculating recency of said information aggregate; and
means for visualizing said recency for a plurality of said information aggregates.

7. System for evaluating an information aggregate, comprising:
a metrics database for storing document indicia including document attributes, associated persons and time-stamped tracked activities;
a query engine responsive to a user request and said metrics database for aggregating documents having same, unique attributes in an information aggregate;
said query engine further for calculating recency value of said aggregate; and
a visualization engine for visualizing said recency values for a plurality of aggregates at a client display.

8. The system of claim 7, said recency being base recency calculated for a given aggregate as time elapsed since the last tracked activity for any said document in said given aggregate.

9. The system of claim 7, said recency being relative recency, calculated as a ratio of life-span of said aggregated to age of said aggregate.

10. The system of claim 7, said recency being cross aggregate recency, calculated for an individual aggregate with respect to a collection of aggregates as a number of time periods since an oldest activity across said collection of aggregates minus said base recency for said individual aggregate.

11. The system of claim 7, said recency being normalized cross-aggregate recency calculated for each individual aggregate as the ratio of a number of time periods since an oldest activity across said collection of aggregates minus said base recency for said individual aggregate to said time periods since said oldest activity across said collection of aggregates.

12. A program storage device readable by a machine, tangibly embodying a program of instructions executable by a machine to perform a method for evaluating information aggregates, said method comprising:
collecting a plurality of documents having non-unique values on a shared attribute into an information aggregate;
time stamping tracked activities on said documents;
calculating recency of said information aggregate; and
visualizing said recency for a plurality of said information aggregates.

13. A program storage device readable by a machine, tangibly embodying a program of instructions executable by a machine to perform a method for evaluating information aggregates, said method comprising:
storing document indicia in a metrics database including document attributes, associated persons and time-stamped tracked activities;
responsive to a user request and said metrics database, aggregating documents having same, unique attributes in an information aggregate;
calculating a recency value of said aggregate; and
visualizing said recency values for a plurality of aggregates at a client display.

14. A computer program product for evaluating information aggregates according to the method comprising
storing document indicia in a metrics database including document attributes, associated persons and time-stamped tracked activities;
responsive to a user request and said metrics database, aggregating documents having same, unique attributes in an information aggregate;
calculating a recency value of said aggregate; and
visualizing said recency values for a plurality of aggregates at a client display.
